(19) United States
(12) Patent Application Publication
(10) Pub. No.: US 2009/0020403 A1
(43) Pub. Date: Jan. 22, 2009

(54) Apparatus for actuating a switch element

(76) Inventors: Robert Scerri, Zejtun (MT); Alexander Galea, DGL Dingli (MT)

Correspondence Address: MILDE & HOFFBERG, LLP, 10 BANK STREET, SUITE 460, WHITE PLAINS, NY, 10606, US

(21) Appl. No.: 12/152,585

(22) Filed: May 15, 2008

(30) Foreign Application Priority Data
May 16, 2007 (DE) 10 2007 023 067.4

(51) Int. Cl. H01H 5/08

(52) U.S. Cl. 200/459

(57) ABSTRACT

An apparatus for actuating a switch element (2) is provided with an operating device (3) that acts upon a tilt member (16) so that the tilt member instantly moves the switch element (2) from a neutral position into a tilted (switched) position. The operating device (3) is mounted pivotally on a housing and includes a pressure member (6) biased by a spring (15) toward the tilt member (16). The tilt member (16) is adapted to be tilted from the neutral to the tilted position about a tilting edge (20).

### BACKGROUND OF THE INVENTION

The present invention relates to apparatus for actuating a switch element.

When switch elements or circuits are actuated by an operator, the switch-over process within the switch element may frequently be dependent on the speed with which the user operates the switch element. In many of the uses of the switching element, this time dependence may be critical.

### SUMMARY OF THE INVENTION

The object underlying the present invention is to provide apparatus for actuating a switch element which ensures actuation of the switch element itself without dependence upon the time an operator takes to operate it.

This object is achieved by providing an arrangement for actuating a switch element having an operating device that acts upon a tilt element so that the tilt element instantly moves the switch element from a neutral position into a tilted (switched) position. The operating device is mounted pivotally on a housing and includes a pressure member biased by a spring toward the tilt member. The tilt member is adapted to be tilted from the neutral to the tilted position about a tilting edge.

The essential advantage of the present invention is that the switch element itself is actuated without any dependence on the period of time the user applies force to the operating device. In other words, in the apparatus according to the invention, the switch element is actuated instantly but not until the switch element operating device has reached a pre-determined switching condition. As a result, the actual actuation of the switch element takes place consistently and instantly whenever the switch element operating device, when moved by the operator, has traveled a pre-determined distance of the switching movement. The time the switching movement takes is unimportant. For reasons of safety, this may often be significant and advantageous.

For a full understanding of the present invention, reference should now be made to the following detailed description of the preferred embodiments of the invention as illustrated in the accompanying drawings.

### BRIEF DESCRIPTION OF THE DRAWINGS

FIGS. 1, 1A and 1B show a section through the apparatus according to the invention for actuating a switch element, with the assembly in its neutral starting position.

FIGS. 2, 2A, 2B, 3 and 4 show the apparatus of FIG. 1 in various intermediate positions in a switching operation, with the actuated position of the switch elements not yet attained.

FIGS. 5, 5A and 5B show the apparatus of FIG. 4 with the switch element actuated instantly and the actuated position attained.

### DESCRIPTION OF THE PREFERRED EMBODIMENTS

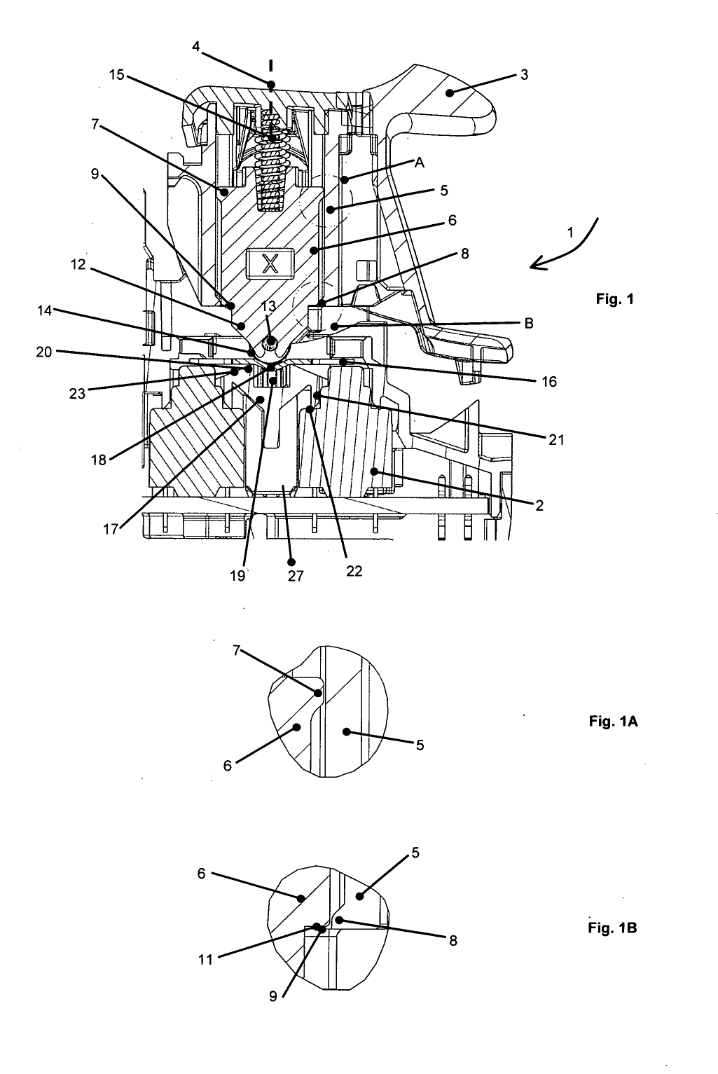

The preferred embodiments of the present invention will now be described with reference to FIGS. 1-5 of the drawings. Identical elements in the various figures are designated with the same reference numerals.

FIGS. 1 to 5 present an assembly for actuating a switch mechanism or switch assembly, referred to as 1, which includes the switch element 2 to be actuated.

Assembly 1 comprises an operating device 3 mounted for pivoting movement about an axis of rotation 4 in the housing of assembly 1. Operating device 3 has, on its side facing switch element 2, guide means holding a plunger or pressure member 6 for sliding movement in a direction preferably perpendicular to axis of rotation 4. Preferably, the guide means has the form of a guide sleeve 5 surrounding pressure member 6—preferably circular and cylindrical in shape—for sliding movement. For mounting purposes, pressure member 6 has, on its side facing the axis of rotation 4, an annular projection 7 adapted to slide along the inner wall surface of the guide sleeve 5 (FIG. 1A).

On its side facing away from axis of rotation 4, the guide sleeve 5 has an annular projection 8 (FIG. 1B) which extends inwardly and engages the outer wall surface of the pressure member 6 in the neutral position (shown in FIG. 1).

Pressure member 6 has an extension portion 12 extending through an opening 11 in annular projection 8 (FIGS. 1B, 2B and 5B) in a direction towards switch element 2. On the level of the axial end of projection 8, a shoulder 9 is provided between the outer wall surface of pressure member 6 and extension portion 12. The shoulder 9 is preferably annular in shape and extends in a direction transverse to pressure member 6.

At the end of extension portion 12 there is preferably provided a roller 14 supported for rotation about an axis of rotation 13; the function of the this roller is explained in greater detail below.

Pressure member 6 is biased in guide means 5 by a spring 15 in a direction towards switch element 2. Spring 15 preferably comprises a compression spring acting between operating element 3 and pressure member 6.

It should be noted that, instead of having the aforesaid roller 14, the free end of extension portion 12 may have its end rounded to conform with the surface of roller 14.

Below the extension portion 12, a snap-over or tilt member 16—preferably in the form of a disk or plate—is mounted in the housing of the assembly 1 with the aid of a holding member 17. Tilt member 16 has a well 18 therein adapted to receive roller in the neutral position shown in FIG. 1. The receiving well bulges toward the switch element 2 and extends into a receiving opening 19 in the holder 17 in a manner such that the periphery of opening 19 forms, on at least one side and preferably on two opposing sides parallel with axis of rotation 13, knife-like edges 20. The snap-over tilt member 16 rests on both sides of the receiving well 18.

Conveniently, the body of switch element 2 has therein a preferably central recess 27 into which the holder 17 is inserted in a manner such that an annular portion 21 of holder 17 engages a shoulder 22 formed in recess 27. On its side facing pressure member 6, the holder 17 has, adjacent edges 20, bevels 23 each angled from an edge 20 into recess 27 and away from the sidewall of pressure member 6.

Starting from FIG. 1, which shows the operating, pressure and tilt members 3, 6 and 16, respectively, in their neutral position, the operation of the inventive assembly 1 will now be explained. In the neutral position shown in FIG. 1, the top portion of pressure member 6 is precisely retained or guided between the inner wall surface of guide sleeve 5 and projection 7 on pressure member 6, while its bottom portion is retained or guided between the outer wall surface of pressure member 6 and the projection on guide sleeve 5 (FIGS. 1A and 1B).

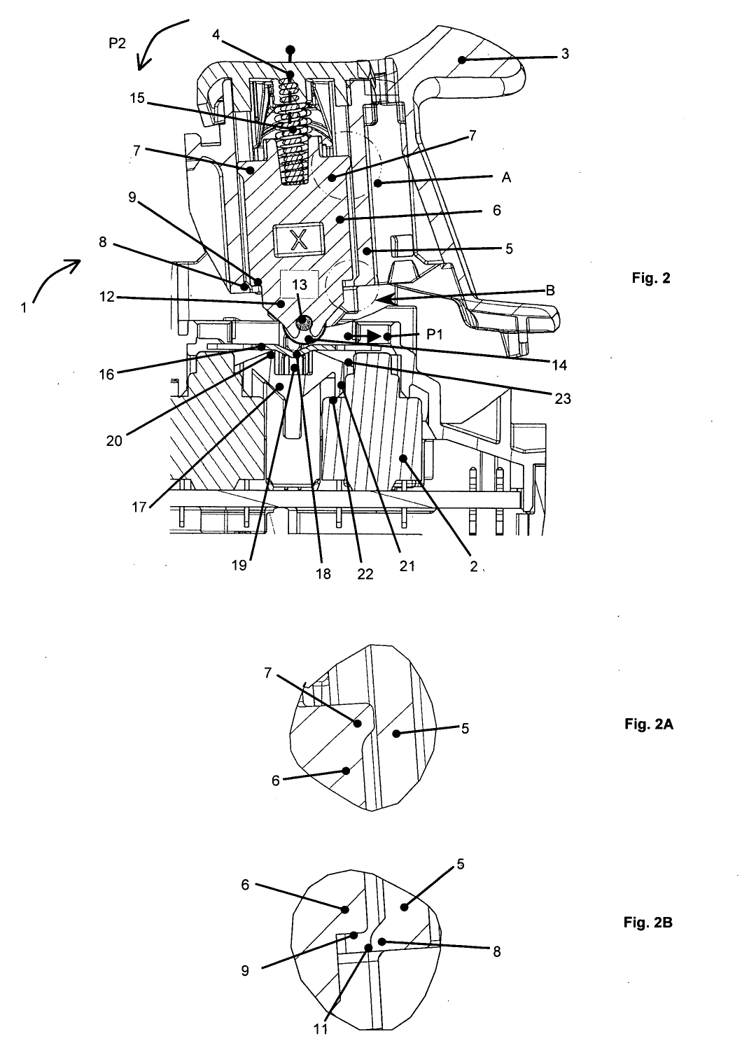

When initially moving the operating device 3 to pivot from the neutral position shown in FIG. 1 about axis of rotation 4 in the direction of arrow P2 (FIG. 2), pressure member 6 together with guide sleeve 5 is moved in a manner such that roller 14 starts to leave well 18 (see arrow P1 in FIG. 2). In the process, pressure member 6 is lifted upwards, i.e. into guide sleeve 5, against the force of spring 3. When this occurs, extension portion 12, held between projection 8 on guide sleeve 5, as well as shoulder 9 on pressure member 6, are moved into guide sleeve 5, moving away from projection 8 of guide sleeve 5 as shown in FIG. 2B. In the process, pressure member 6 in guide sleeve 5 performs a movement which allows the stroke of pressure member 6 needed for moving roller 14 in the direction of arrow P1.

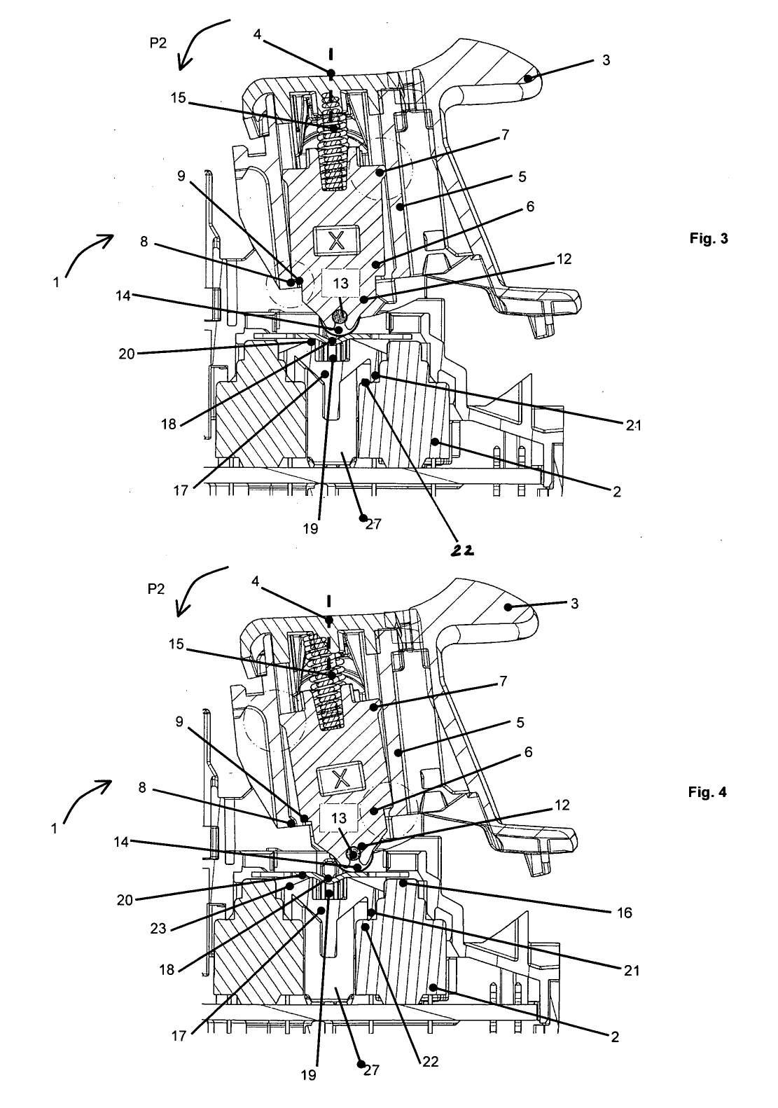

FIGS. 3 and 4 show positions in which operating means 3 starts to become unstable when operating device 3 continues to move in the direction of arrow P2, with roller 14 continuing to move away from well 14. FIG. 3 shows a position in which the force exerted by spring-biased pressure member 6 via roller 14 still acts on the side facing well 18 of edge 20.

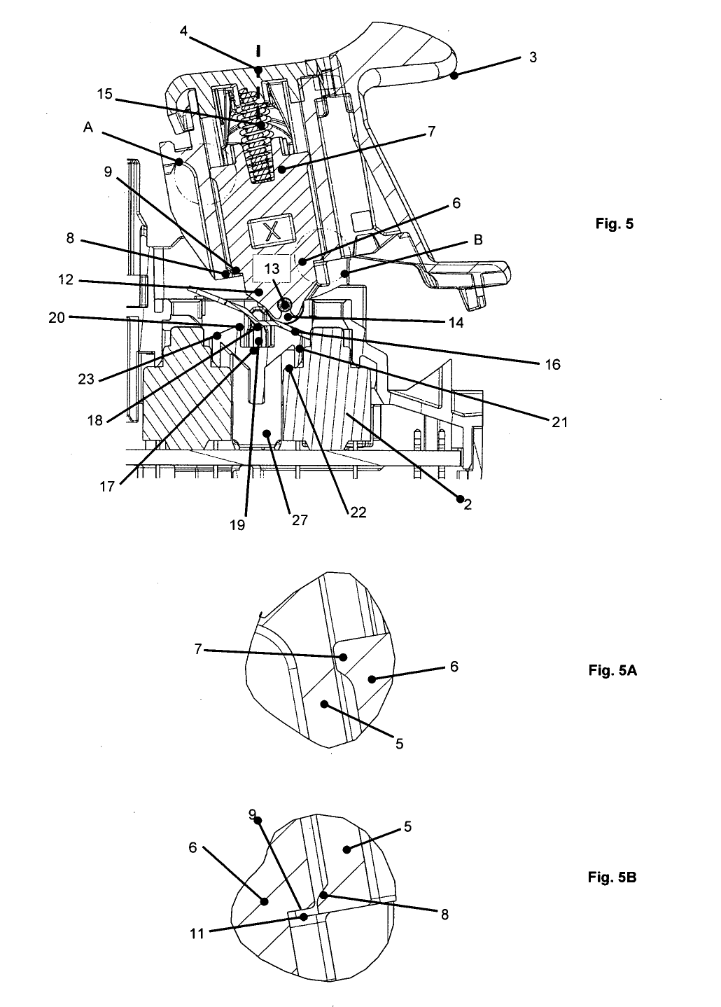

FIG. 4 shows the position in which the aforesaid force acts in a direction towards the side facing away from well 14 of edge 20 so that tilt member 16 snaps over or tilts about a line defined by edge 20 so as to rest on bevel 23 in its tilted position as shown in FIG. 5. In the process, the energy stored in spring member 15 is released to instantly actuate switch element 2.

When passing from the positions in the guide sleeve shown in FIGS. 2 and 3, it is preferred for pressure member 6 to tilt in a direction transverse to the longitudinal axis of guide sleeve 5 as shown, thereby accelerating the tilting movement of tilt element 16.

Moving the operating device 3 against the direction of arrow P2 will restore the neutral position shown in FIG. 1.

There has thus been shown and described a novel apparatus for actuating a switch element which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. Apparatus for actuating a switch element, wherein an operating device and a switch element are disposed in a housing, the improvement wherein said operating device acts upon a snap-over tilt member so as to move the latter from a neutral to a tilted position for instantly actuating the switch element.

2. Apparatus as defined in claim 1, wherein the operating device is mounted in the housing for pivoting movement about an axis of rotation and includes a pressure member biased by a spring element toward the tilt member.

3. Apparatus as defined in claim 2, wherein the pressure member is disposed inside a guide sleeve of the operating device and wherein the spring element is in the form of a compression spring having an end acting against operating device and another end acting against pressure member.

4. Apparatus as defined in claim 2, wherein the tilt member has formed therein a well portion engaging an end of the pressure member that faces the tilt member, with the tilt member supported in such a manner as to assume a neutral position when the end portion of the pressure member engages the well portion and to attain the tilted position when the end portion is moved a predetermined distance from well portion as the operating device pivots.

5. Apparatus as defined in claim 4, wherein the tilt member is supported in a holder in such a manner that the well portion in its neutral position extends into a receiving opening in the holder, and wherein a knife-like tilting edge is provided on at least one side of the receiving opening, with the tilt member tiltable instantly from its neutral into its tilted position about the tilting edge.

6. Apparatus as defined in claim 5, wherein a support means for the tilt member in the tilted position thereof, is provided on the side of the tilting edge facing away from receiving opening.

7. Apparatus as defined in claim 6, wherein said support means is in the form of a bevel adjacent the tilting edge.

8. Apparatus as defined in claim 4, wherein the end portion of the pressure member has a roller extending into the well portion of the tilt member.

9. Apparatus as defined in claim 4, wherein the end portion of the pressure member is rounded to conform with the shape of the well portion.

10. Apparatus as defined in claim 3, wherein the pressure member has, on its side facing away from the tilt member, a projection slidably engaging the inner wall surface of the guide sleeve.

11. Apparatus as defined in claim 3, wherein the guide sleeve has, on its side facing the tilt member, a projection engaging the outer wall surface of pressure member when in the neutral position.

12. Apparatus as defined in claim 11, wherein the pressure member has a shoulder which, when in the neutral position, lies below the level of the projection on the guide sleeve, said shoulder leading towards a reduced-diameter extension portion so that a movement of the pressure member inside guide sleeve in a direction transverse to tilting edge is possible when the pressure member has moved into the guide sleeve and the shoulder is located in the guide sleeve above the projection.

13. Apparatus as defined in claim 1, wherein the tilt member is in the form of a plate, and wherein the side of the plate facing away from tilting edge in the tilted position actuates the switch element in this tilted position.
